(19) United States
(12) Patent Application Publication
(10) Pub. No.: US 2020/0204023 A1
(43) Pub. Date: Jun. 25, 2020

(54) ELECTRICAL MACHINE

(71) Applicant: Mahle International GmbH, Stuttgart (DE)

(72) Inventors: Mirko Hoerz, Esslingen (DE); Hans-Ulrich Steurer, Stuttgart (DE); Josef Sonntag, Nuertingen (DE); Stojan Markic, Kojsko (SI); Andrej Licen, Branik (SI); Aleks Medvescek, Rence (SI); Peter Sever, Murska Sobota (SI); Philip Grabherr, Stuttgart (DE)

(21) Appl. No.: 16/614,795

(22) PCT Filed: May 18, 2018
(86) PCT No.: PCT/EP2018/063138

§ 371 Date: Nov. 18, 2019

(30) Foreign Application Priority Data
May 19, 2017 (DE) 10 2017 208 564.9

(51) Int. Cl. H02K 3/24; H02K 1/20; H02K 9/197

(52) U.S. Cl. CPC H02K 3/24; H02K 9/197; H02K 1/20

(57) ABSTRACT

An electrical machine may include a rotor rotatable about a rotation axis defining an axial direction of the electrical machine, and a stator having stator windings, and a coolant distributor chamber and a coolant collector chamber arranged axially at a distance therefrom, wherein the coolant distributor chamber may communicate fluidically with the coolant collector chamber via at least one cooling channel through which a coolant may be flowable to cool the stator windings, wherein at least one stator winding may be embedded into a plastic composition composed of an electrically insulating plastic. At least one of the coolant distributor chamber and the coolant collector chamber may be arranged in a region of at least one of a first and a second axial end section of at least one stator winding, and may arranged at least partly in the plastic composition for thermal coupling to the at least one stator winding.

### CROSS-REFERENCE TO RELATED APPLICATIONS

This application claims priority to International Patent Application No. PCT/EP2018/063138 filed May 18, 2018, which also claims priority to German Patent Application DE 10 2017 208 564.9 filed May 19, 2017, each of which is hereby incorporated by reference in its entirety.

### TECHNICAL FIELD

The invention relates to an electrical machine, particularly for a vehicle, and to a vehicle comprising such a machine.

An electrical machine of this type can generally be an electric motor or a generator. The electrical machine can be embodied as external rotor or as internal rotor.

### BACKGROUND

A machine of the generic type is known from U.S. Pat. No. 5,214,325, for example. It comprises a housing, which surrounds an interior and which has a casing extending circumferentially in a circumferential direction of the housing and radially delimiting the interior, axially at one side a rear side wall axially delimiting the interior, and axially at the other side a front side wall axially delimiting the interior. A stator of the machine is fixedly connected to the casing. A rotor of the machine is arranged in the stator, wherein a rotor shaft of the rotor is mounted rotatably by way of a front shaft bearing on the front side wall.

The stator of a conventional electrical machine typically comprises stator windings, which are electrically energized during operation of the machine. This gives rise to heat which has to be dissipated in order to avoid overheating and associated damage or even destruction of the stator. For this purpose, it is known from conventional electrical machines to equip the latter with a cooling device for cooling the stator—in particular said stator windings. Such a cooling device comprises one or more cooling channels through which a coolant flows and which are arranged in the vicinity of the stator windings in the stator. Heat transfer from the stator windings to the coolant enables heat to be dissipated from the stator.

In this case, it proves to be disadvantageous that efficient heat transfer from the stator to the coolant flowing through the respective cooling channel is only associated with considerable structural complexity. However, this has a disadvantageous effect on the production costs of the electrical machine.

Therefore, it is an object of the present invention to provide an improved embodiment for an electrical machine in which this disadvantage is largely or evenly completely eliminated. In particular, the intention is to provide an improved embodiment for an electrical machine which is distinguished by improved cooling of the stator windings of the stator.

### SUMMARY

This object is achieved by means of the subject matter of the independent patent claims. The dependent patent claims relate to preferred embodiments.

Accordingly, the basic concept of the invention is to embed the stator windings of an electrical machine into a plastic composition composed of a plastic, in which are also provided a coolant distributor chamber and a coolant collector chamber for a coolant which absorbs the waste heat generated by the stator windings as a result of thermal interaction. In this case, the plastic is used as a heat transfer medium for transferring heat from the stator windings to the coolant.

A particularly good heat transfer between the stator windings and the coolant passed through the stator is produced in this way. This holds true particularly if a plastic having a high thermal conductivity is used. So-called thermosetting plastics, in particular, are suitable for this purpose. Since a plastic typically also has the properties of an electrical insulator, at the same time this ensures that the stator windings to be cooled are not electrically short-circuited in an undesired manner by the plastic. Consequently, even in the case of high evolution of waste heat in the stator, such as occurs for example during operation of the electrical machine under high load, it can be ensured that the waste heat that arises can be dissipated from the stator. Damage or even destruction of the electrical machine as a result of overheating of the stator can thus be avoided. The plastic composition—essential to the invention—with the coolant distributor chamber and/or respectively coolant collector chamber formed therein can be produced by means of injection molding, in the course of which the plastic is injection-molded around the stator windings to be cooled. The embedding of the stator windings and the cooling channel into the plastic composition therefore turns out to be very simple.

For the purpose of cooling the stator windings, the coolant proceeding from the coolant collector chamber embodied in the plastic composition can be distributed among a plurality of cooling channels in which the coolant absorbs waste heat from the stator windings as a result of thermal interaction. After flowing through the cooling channels, the coolant can be collected in the coolant collector chamber. Since the coolant distributor chamber and the coolant collector chamber are arranged in the plastic composition according to the invention, the coolant present in the coolant distributor chamber can be used for cooling the stator winding already before being distributed among the cooling channels. The same correspondingly holds true for the coolant collected in the coolant collector chamber after flowing through the cooling channels. Since the coolant distributor chamber and/or respectively coolant collector chamber are/is thus arranged directly adjacent to the stator windings to be cooled, an effective thermal coupling of the coolant distributor chamber and/or respectively coolant collector chamber to the stator windings to be cooled is achieved in this way.

An electrical machine according to the invention, particularly for a vehicle, comprises a rotor, which is rotatable about a rotation axis. The rotation axis defines an axial direction of the electrical machine. The machine furthermore comprises a stator having stator windings. The machine furthermore comprises a coolant distributor chamber and a coolant collector chamber arranged axially at a distance therefrom. A coolant can flow through the coolant distributor chamber for the purpose of cooling the waste heat generated by the stator winding and said coolant distributor chamber communicates fluidically with the coolant collector chamber by means of at least one cooling channel. Preferably, at least two, particularly preferably a plurality of such cooling channels are provided. At least one stator winding is embedded at least in sections, preferably completely, into a plastic composition composed of an electrically insulating plastic for the purpose of thermal coupling to the coolant. In this case, the coolant distributor chamber and/or the coolant collector chamber are/is arranged in the region of a first and/or second axial end section of at least one stator winding. Preferably, the coolant distributor chamber and/or the coolant collector chamber are/is arranged in an axial extension of the first and/or second end section. According to the invention, the coolant distributor chamber and/or the coolant collector chamber are/is embodied at least partly in the plastic composition and thus at least partly delimited by the latter for the purpose of thermal coupling to the at least one stator winding.

In accordance with one preferred embodiment, the coolant distributor chamber and/or the coolant collector chamber in a longitudinal section along the rotation axis surround(s) the first and/or second axial end section of the at least one stator winding in a U-shaped or C-shaped manner. In this way, the end sections particularly subjected to thermal loading are virtually surrounded by the coolant distributor chamber and/or by the coolant collector chamber, with the result that a particularly good thermal coupling of the coolant to the end sections of the respective stator winding can be effected.

Particularly preferably, the coolant distributor chamber and/or the coolant collector chamber in the longitudinal section along the axial direction therefore have/has a U-shaped or C-shaped geometric shaping.

In one advantageous development, the coolant distributor chamber and/or the coolant collector chamber are/is also arranged radially on the outside of the first and/or second end section of the at least one stator winding.

Expediently, the coolant distributor chamber and/or the coolant collector chamber can have a ring-shaped geometric shaping in a cross section perpendicular to the rotation axis of the rotor. This allows a plurality of cooling channels to be arranged at a distance from one another along the circumferential direction along the stator.

Particularly preferably, the at least one plastic composition at least partly delimits the coolant distributor chamber and/or the coolant collector chamber. The provision of a separate housing can thus be obviated.

In accordance with a further preferred embodiment, the coolant distributor chamber and/or the coolant collector chamber are/is embodied by a cavity provided at least partly, preferably completely, in the plastic composition. The provision of a separate enclosure or a housing for delimiting the coolant distributor chamber and/or coolant collector chamber can thus be obviated. This is associated with not inconsiderable cost advantages.

In accordance with one preferred embodiment, the at least one cooling channel is also embedded into the at least one plastic composition composed of the electrically insulating plastic. This ensures a good thermal coupling of the coolant flowing through the cooling channel to the relevant stator windings.

In accordance with another preferred embodiment, the stator has stator teeth extending along the axial direction and arranged at a distance from one another along a circumferential direction, said stator teeth carrying the stator windings. In this embodiment, the plastic composition together with the at least one cooling channel and the at least one stator winding is arranged in an interspace embodied between two stator teeth that are adjacent in the circumferential direction. This measure ensures a particularly good heat transfer between the stator windings and the cooling channel since the cooling channel is arranged in the interspace in direct proximity to the stator windings to be cooled. Furthermore, said interspace between the stator teeth can be used during the production of the plastic composition in the manner of a mold into which the plastic of the plastic composition is injected. This simplifies the production of the plastic composition since the provision of a separate mold can be obviated.

A further preferred embodiment proposes subdividing the interspace into a first and a second subspace. In this configuration, the at least one stator winding is arranged in the first subspace. The at least one cooling channel is arranged in the second subspace. A positioning aid is embodied between the two subspaces, by means of which positioning aid the at least one cooling channel is positionable in the second subspace. This measure allows precise and stable positioning of the cooling channel—which is typically a tube body or a flat tube—, particularly if the latter together with the stator windings in the interspace between the two stator teeth is encapsulated by injection molding with the plastic that produces the plastic composition.

In one advantageous development of this configuration, the positioning aid comprises two projections embodied at two stator teeth which are adjacent in the circumferential direction. The two projections face one another in the circumferential direction of the rotor and project into the interspace for the purpose of positioning the cooling channel. This configuration allows a particularly accurate alignment of the cooling channel in the interspace before encapsulation by injection molding with the plastic of the plastic composition.

In accordance with one preferred embodiment, the plastic composition arranged in the interspace consists of a single plastic material. In this embodiment, an additional electrical insulation composed of an electrically insulating material is arranged in the interspace, preferably between the stator winding or plastic composition and the stator tooth. Since, in this embodiment, only a single plastic material has to be introduced into the interspaces, the production of the plastic composition composed of said plastic can be effected in a single injection-molding step. The production of the plastic composition therefore turns out to be particularly simple, which is associated with cost advantages.

Expediently, the electrically insulating plastic of the plastic composition comprises a thermosetting plastic or is a thermosetting plastic. Alternatively, the electrically insulating plastic of the plastic composition can comprise a thermoplastic or be a thermoplastic. A combination of a thermosetting plastic and a thermoplastic is also conceivable in a further variant.

Expediently, the plastic composition substantially completely fills the interspace. The formation of undesired interspaces, for instance in the manner of air gaps, which would result in an undesired reduction of the heat transfer, is avoided in this way.

In accordance with one preferred embodiment, the at least one plastic composition projects axially, preferably on both sides, from the interspace. The plastic composition can thus be used for embodying the coolant distributor chamber and/or coolant collector chamber.

In accordance with another preferred embodiment, the at least one cooling channel is arranged radially outside and/or radially within the respective stator winding in the interspace. This enables a space-saving arrangement of the cooling channel near the stator windings to be cooled, with the result that the electrical machine requires only little structural space for the cooling of the stator windings.

One preferred configuration proposes embodying the at least one cooling channel as a tube body surrounding a tube body interior. In this variant, at least one separating element is shaped at the tube body and subdivides the tube body interior into at least two partial cooling channels which are fluidically separated from one another. The tube body can be reinforced by means of said separating elements, and so its mechanical strength increases.

Expediently, the tube body can be embodied as a flat tube having two broad sides and two narrow sides.

One advantageous development proposes embodying the tube body as a flat tube which extends along the axial direction and has two broad sides and two narrow sides in a cross section perpendicular to the axial direction. Expediently, in the cross section perpendicular to the axial direction at least one broad side of the flat tube extends perpendicular to the radial direction. In this case, a length of the two broad sides can preferably be at least four times, preferably at least ten times, a length of the two narrow sides.

Particularly preferably, the at least one cooling channel is arranged completely in the plastic composition composed of the plastic.

In accordance with a further preferred embodiment, the stator in a cross section perpendicular to the axial direction is embodied in a ring-shaped fashion and has stator teeth extending along the axial direction and arranged at a distance from one another along a circumferential direction of the stator, said stator teeth carrying the stator windings. In this embodiment, the plastic composition together with the at least one cooling channel and the at least one stator winding is arranged in an interspace embodied between two stator teeth that are adjacent in the circumferential direction. This measure ensures a particularly effective heat transfer between the stator windings and the cooling channel since the cooling channel arranged in the interspace is situated in direct proximity to the stator windings to be cooled. Furthermore, the interspace between the stator teeth can be used during the production of the plastic composition in a manner of a mold into which the plastic of the plastic composition is injected. This simplifies the production of the plastic composition since the provision of a separate mold can be obviated.

In accordance with a further preferred embodiment, the at least one cooling channel is formed by at least one perforation, preferably by a plurality of perforations, which is/are provided in the plastic composition and through which the coolant can flow. Particularly preferably, a plurality of such perforations are provided. The provision of a separate tube body or the like for delimiting the cooling channel is obviated in this variant. This is associated with reduced production costs. Said perforation can be realized in the form of a through hole introduced into the plastic composition by means of a suitable drilling tool. The provision of a separate tube body or the like for delimiting the cooling channel is obviated in this variant. This is associated with reduced production costs.

Expediently, at least one perforation in a cross section perpendicular to the axial direction can have the geometry of a rectangle having two broad sides and two narrow sides. In this way, the advantageous geometry of a flat tube is imparted to the perforation, said geometry in turn allowing a structural-space-saving arrangement of the cooling channel in direct proximity to the stator winding(s) to be cooled.

In accordance with a further preferred embodiment, at least one cooling channel is arranged in the stator body and is formed by at least one perforation through which the coolant can flow. Said perforation can be realized in the form of a through hole introduced into the stator body by means of a suitable drilling tool in the course of the production of the electrical machine. The provision of a separate tube body or the like for delimiting the cooling channel is obviated in this variant. This is associated with reduced production costs.

In a further preferred embodiment, the perforation forming the cooling channel is embodied as open toward the interspace. Moreover, said perforation is closed in a fluid-tight fashion by the plastic composition arranged in the interspace. In this variant, the perforations are able to be produced particularly simply, which is associated with cost advantages during production.

Expediently, the at least one cooling channel is arranged in the stator body in the region between two adjacent stator teeth with respect to the circumferential direction. This makes it possible to arrange the cooling channel near the stator windings to be cooled, which improves the heat transfer from the stator windings to the cooling channel.

In accordance with another preferred embodiment, at least one cooling channel is provided in the plastic composition and at least one further cooling channel is provided in the stator body. This variant requires particularly little structural space since both the stator body and the plastic composition are used for accommodating the cooling channel.

In accordance with another preferred embodiment, the stator is arranged along the axial direction between a first and a second end shield, which lie opposite one another along the axial direction. In this embodiment, a part of the coolant distributor chamber is arranged in the first end shield. Alternatively or additionally, a part of the coolant collector chamber is arranged in the second coolant collector chamber.

In accordance with another preferred embodiment, a coolant feed is embodied in the first end shield and fluidically connects the coolant distributor chamber to a coolant inlet provided on the outside, preferably on the end side, of the first end shield. Furthermore, a coolant discharge is embodied in the second end shield and fluidically connects the coolant collector chamber to a coolant outlet provided on the outside, preferably on the end side, of the second end shield. Particularly preferably, the coolant feed can be thermally connected to a first shaft bearing for the rotatable mounting of the stator, said first shaft bearing being provided in the first end shield. In an analogous manner, the coolant discharge can be thermally connected to a second shaft bearing for the rotatable mounting of the stator, said second shaft bearing being provided in the second end shield.

Particularly preferably, the plastic composition is an injection-molded composition composed of an electrically insulating plastic. The application of an injection-molding method simplifies and accelerates the production of the plastic composition. This results in cost advantages during the production of the electrical machine.

Particularly preferably, the entire plastic composition, that is to say in particular the plastic composition arranged in the interspaces between the stator teeth and the plastic composition delimiting the coolant distributor chamber and the coolant collector chamber, is embodied in integral fashion. This measure simplifies the production of the electrical machine, which is associated with cost advantages.

In one advantageous development, the stator comprises a, preferably ring-shaped, stator body, from which the stator teeth protrude. In this development, the plastic composition composed of the electrically insulating plastic is arranged on an outer circumferential side of the stator body and preferably forms a plastic coating on said outer circumferential side. The stator can thus be electrically insulated from the surroundings. The provision of a separate housing for accommodating the stator body can thus be obviated. A coating of at least one or both end sides of the stator body with the plastic composition is also conceivable in an optional variant. In a further variant, the plastic composition can envelop, preferably completely, the stator body.

Particularly preferably, the coolant distributor chamber and/or the coolant collector chamber axially adjoin(s) the at least one stator winding. Since the coolant distributor chamber and/or coolant collector chamber are/is thus arranged directly adjacent to the stator windings to be cooled with respect to the axial direction, an effective thermal coupling of the coolant distributor chamber and/or coolant collector chamber to the stator windings to be cooled is achieved in this way.

In accordance with a further preferred embodiment, the coolant collector chamber and/or the coolant distributor chamber adjoin(s) the at least one stator winding radially on the outside and/or radially on the inside and axially at the end face, with preference adjoin(s) the first and/or respectively second axial end section of said at least one stator winding.

In accordance with one preferred embodiment, the plastic composition at least partly surrounds at least one winding section of at least one stator winding that projects axially from the interspace of the stator body, and in this case partly delimits the coolant distributor chamber and/or the coolant collector chamber, such that said winding section of the stator winding is electrically insulated from the coolant. An undesired electrical short circuit of the coolant with the stator winding during operation of the electrical machine is prevented in this way.

In accordance with one advantageous development, the coolant distributor chamber communicates fluidically with the coolant collector chamber by means of a plurality of cooling channels.

Expediently, the plurality of cooling channels extend at a distance from one another along the axial direction. This measure ensures that all axial sections of the stator windings are cooled.

Preferably, the cooling channels are arranged at a distance from one another along a circumferential direction of the stator. This measure ensures that along the circumferential direction all stator windings are cooled.

In accordance with another preferred embodiment, the coolant distributor chamber and/or coolant collector chamber are/is arranged exclusively in an axial extension of the stator body adjacent thereto. Preferably, in this embodiment, the coolant distributor chamber and/or the coolant collector chamber do[es] not project beyond the stator body or stator along a radial direction thereof. This embodiment requires only very little structural space in a radial direction.

Particularly preferably, at least one stator winding is embodied such that it is electrically insulated from the coolant and from the stator body at least in the region within the respective interspace during operation of the electrical machine. Particularly preferably, this applies to all the stator windings of the electrical machine. An undesired electrical short circuit of the stator winding with the stator body or—during operation of the electrical machine—with the coolant is prevented in this way.

Particularly expediently, this electrical insulation of the at least one stator winding from the stator body, preferably also from the stator teeth delimiting the interspace, is formed completely by the plastic composition and/or by the additional insulation—already mentioned above. The provision of a further electrical insulation can be obviated in this way.

In accordance with another preferred embodiment, the additional electrical insulation extends within the interspace over the entire length of the interspace as measured along the axial direction, such that it insulates the stator winding from the stator body and from the stator teeth delimiting the interspace.

In accordance with one advantageous development, the additional electrical insulation encloses the stator winding within the interspace over at least the entire length of the interspace along the circumference thereof.

In one particularly preferred embodiment, the at least one stator winding is also electrically insulated from the cooling channel embodied as a tube body. In this case, the electrical insulation is formed by the plastic composition and/or the additional electrical insulation.

Particularly preferably, the stator windings can be part of a distributed winding.

The invention furthermore relates to a vehicle, in particular a motor vehicle, comprising an electrical machine presented above. The above-explained advantages of the electrical machine are therefore also applicable to the vehicle according to the invention.

Further important features and advantages of the invention are evident from the dependent claims, from the drawings and from the associated description of the figures with reference to the drawings.

It goes without saying that the features mentioned above and those yet to be explained below are usable not only in the combination respectively indicated, but also in other combinations or by themselves, without departing from the scope of the present invention.

Preferred exemplary embodiments of the invention are illustrated in the drawings and are explained in greater detail in the following description.

### BRIEF DESCRIPTION OF THE DRAWINGS

In the figures, schematically in each case:

FIG. 1 shows one example of an electrical machine according to the invention in a longitudinal section along the rotation axis of the rotor,

FIG. 2 shows the stator of the electrical machine in accordance with FIG. 1 in a cross section perpendicular to the rotation axis of the rotor,

FIG. 3 shows a detail of the stator from FIG. 2 in the region of an interspace between two stator teeth which are adjacent in the circumferential direction,

FIG. 4 shows a variant of the electrical machine from FIG. 1, in which the coolant flowing through the cooling channels is also used for cooling the shaft bearings of the rotor,

FIGS. 5-9 show further different configuration variants for the interspace between two stator teeth, which interspace is filled with plastic composition.

### DETAILED DESCRIPTION

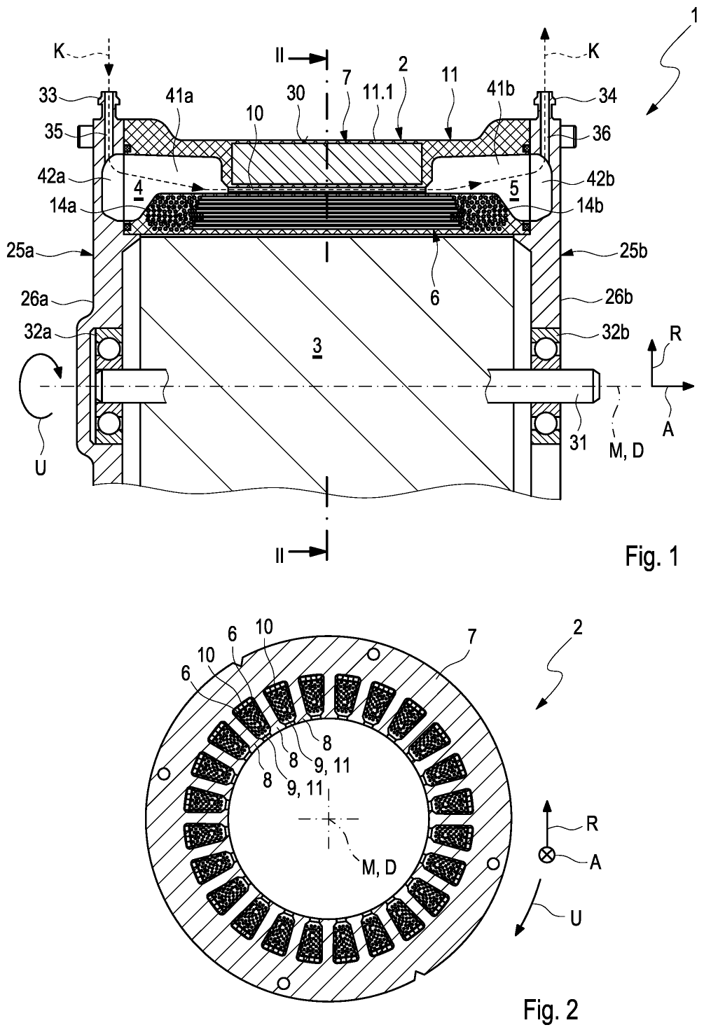

FIG. 1 illustrates one example of an electrical machine 1 according to the invention in a sectional illustration. The electrical machine 1 is dimensioned such that it can be used in a vehicle, preferably in a road vehicle.

The electrical machine 1 comprises a rotor 3, which is merely illustrated roughly schematically in FIG. 1, and a stator 2. For elucidation, FIG. 2 illustrates the stator 2 in a cross section perpendicular to the rotation axis D along the sectional line II-II from FIG. 1 in a separate illustration. In accordance with FIG. 1, the rotor 3 has a rotor shaft 31 and can have a plurality of magnets, not illustrated more specifically in FIG. 1, the magnetic polarization of which magnets alternates along the circumferential direction U. The rotor 3 is rotatable about a rotation axis D, the position of which is defined by the central longitudinal axis M of the rotor shaft 31. The rotation axis D defines an axial direction A extending parallel to the rotation axis D. A radial direction R is perpendicular to the axial direction A. A circumferential direction U rotates about the rotation axis D.

As can be discerned from FIG. 1, the rotor 3 is arranged in the stator 2. Consequently, the electrical machine 1 shown here is a so-called internal rotor. However, a realization as a so-called external rotor is also conceivable, in which the rotor 3 is arranged outside the stator 2. The rotor shaft 31 is mounted in a first shaft bearing 32a and, axially at a distance therefrom, in a second shaft bearing 32b rotatably about the rotation axis D on the stator 2.

The stator 2 additionally comprises, in a known manner, a plurality of stator windings 6, which are electrically energizable for the purpose of generating a magnetic field. Magnetic interaction between the magnetic field generated by the magnets of the rotor 3 and the magnetic field generated by the stator windings 6 causes the rotor 3 to rotate.

The cross section in FIG. 2 reveals that the stator 2 can have a ring-shaped stator body 7, for example composed of iron. In particular, the stator body 7 can be formed from a plurality of stator body plates (not shown) which are stacked one on top of another along the axial direction A and are adhesively bonded to one another. A plurality of stator teeth 8 are integrally formed on the stator body 7 radially on the inside, which stator teeth extend along the axial direction A, protrude away from the stator body 7 radially inward and are arranged at a distance from one another along the circumferential direction U. Each stator tooth 8 carries a stator winding 6. The individual stator windings 6 together form a winding arrangement. Depending on the number of magnetic poles to be formed by the stator windings 6, the individual stator windings 6 of the entire winding arrangement can be correspondingly electrically wired together.

During operation of the machine 1, the electrically energized stator windings 6 generate waste heat which has to be dissipated from the machine 1 in order to prevent overheating and associated damage or even destruction of the machine 1. Therefore, the stator windings 6 are cooled with the aid of a coolant K which is passed through the stator 2 and absorbs the waste heat generated by the stator windings 6 by means of heat transfer.

In order to pass the coolant K through the stator 2, the machine 1 comprises a coolant distributor chamber 4, into which a coolant K can be introduced via a coolant inlet 33. A coolant collector chamber 5 is arranged at a distance from the coolant distributor chamber 4 along the axial direction A. The coolant distributor chamber 4 communicates fluidically with the coolant collector chamber 5 by means of a plurality of cooling channels 10, only a single one of which is discernible in the illustration in FIG. 1. In a cross section perpendicular to the axial direction A, which cross section is not shown in the figures, the coolant distributor chamber 4 and the coolant collector chamber 5 can each have a ring-shaped geometry. Along the circumferential direction U, a plurality of cooling channels 10 are arranged at a distance from one another, which cooling channels extend in each case along the axial direction A from the ring-shaped coolant distributor chamber 4 to the ring-shaped coolant collector chamber 5. The coolant K introduced into the coolant distributor chamber 4 via the coolant inlet 33 can thus be distributed among the individual cooling channels 10. After flowing through the cooling channels 10 and absorbing heat from the stator windings, the coolant K is collected in the coolant collector chamber 5 and guided out of the machine 1 again via a coolant outlet 34 provided on the stator 2.

As revealed by the illustration in FIGS. 1 and 2, the stator windings 6 are arranged in interspaces 9 embodied between in each case two stator teeth 8 which are adjacent in the circumferential direction U. Said interspaces 9 are also known to a person skilled in the relevant art as so-called “stator slots” or “stator slits”, which extend along the axial direction A just like the stator teeth 8.

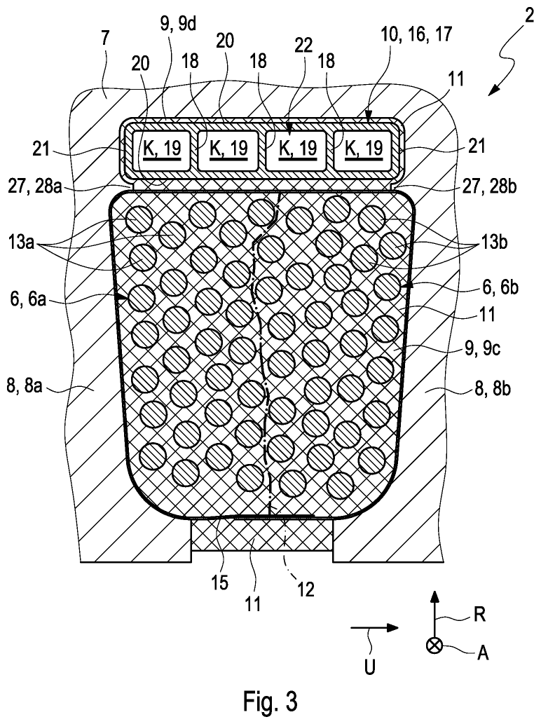

Attention shall now be directed to the illustration in FIG. 3, which shows a detailed illustration of an interspace 9 embodied between two stator teeth 8 which are adjacent in the circumferential direction U—said stator teeth hereinafter also being referred to as stator teeth 8a, 8b. In order to improve the heat transfer of the waste heat generated by the stator windings 6 to the coolant K flowing through the cooling channels 10, in accordance with FIG. 3, a plastic composition 11 composed of a plastic is in each case provided in the interspaces 9. Particularly preferably, the plastic composition 11 is an injection-molded composition composed of an electrically insulating plastic. The application of an injection-molding method simplifies and accelerates the production of the plastic composition. In the example in FIG. 3, the plastic composition 11 consists of a single plastic material. The cooling channel 10 arranged in the interspace 9 and the stator winding 6 arranged in the same interspace 9 are embedded into the plastic composition 11, which can consist of a thermosetting plastic or a thermoplastic, for example. It goes without saying that the stator winding 6 arranged in the interspace 9 in accordance with FIG. 3 in each case is partly associated with a first stator winding 6a, carried by a first stator tooth 8a, and is partly assigned to a second stator winding 6b, carried by a second stator tooth 8b, which is adjacent to the first stator tooth 8a in the circumferential direction U. For the elucidation of this scenario, a virtual separating line 12 is depicted in FIG. 3. The winding wires 13a shown to the left of the separating line 12 in FIG. 3 belong to the stator winding 6a carried by the stator tooth 8a. The winding wires 13b shown to the right of the separating line 12 belong to the stator winding 6b carried by the stator tooth 8b.

As further revealed by the detailed illustration in FIG. 3, an additional electrical insulation 15 composed of an electrically insulating material is arranged in the respective interspace 9 between the plastic composition 11 and the stator body 7 or the two stator teeth 8a, 8b delimiting the interspace 9 in the circumferential direction U. An electrical insulation 15 composed of paper proves to be particularly cost-effective. In this way, in the case where the plastic composition 11 cracks on account of thermal overloading or is damaged in some other way, it is possible to avoid an undesired electrical short circuit of the stator winding 6 with the material of the stator body 7 or of the stator teeth 8 or 8a, 8b—typically iron or some other suitable electrically conductive material.

As demonstrated by the detailed illustration in FIG. 3, the cooling channels 10 can be formed in each case by a tube body 16, for example composed of aluminum, which surrounds a tube body interior 22. Optionally, as shown in the detailed illustration in FIG. 3, one or more separating elements 18 can be shaped on the tube body 16, said one or more separating elements subdividing the cooling channel 10 into partial cooling channels 19 fluidically separated from one another. In this way, the flow behavior of the coolant K in the cooling channel 10 can be improved, which is associated with an improved heat transfer to the coolant K. Moreover, the tube body 16 is additionally mechanically reinforced in this way. Three such separating elements 18 are illustrated by way of example in FIG. 3, thus resulting in four partial cooling channels 19. Of course, a different number of separating elements 18 is possible in variants of the example. The tube body 16 forming the cooling channel 10 is embodied as a flat tube 17 having two broad sides 20 and two narrow sides 21 in a cross section perpendicular to the rotation axis D of the rotor 3 (cf. FIG. 3). In the cross section perpendicular to the axial direction A as shown in FIG. 3, the two broad sides 20 of the flat tube 70 extend perpendicularly to the radial direction R. A length of the two broad sides 20 is at least four times, preferably at least ten times, a length of the two narrow sides 21.

In the example in FIGS. 1 to 3, the cooling channels 10 are arranged radially outside the stator windings 6 in the respective interspace 9. The radial distance between the cooling channels 10 and the rotation axis D of the rotor 3 is thus greater than that between the stator windings 6 and the rotation axis D. However, an arrangement of the cooling channels 10 radially on the inside is also conceivable.

In the text that follows, reference is made once again to FIG. 1. As demonstrated illustratively by FIG. 1, the plastic composition 11 embodied in integral fashion can project from the interspaces 9 axially on both sides. This allows the coolant distributor chamber 4 and, alternatively or additionally, the coolant collector chamber 5 also to be embedded into the plastic composition 11 for the purpose of thermal coupling to axial end sections 14a, 14b of the respective stator winding 6, which are arranged axially outside the respective interspace 9. In other words, in this embodiment variant, the one plastic composition 11 delimits the coolant distributor chamber 4 and the coolant collector chamber 5 at least partly in each case.

In this way, even in the region of the axial end sections 14a, 14b of the relevant stator winding 6, said end sections usually being particularly subjected to thermal loading, it is possible to produce an effective heat transfer to the coolant K present in the coolant distributor chamber 4 and/or coolant collector chamber 5. This measure allows particularly effective cooling of the two axial end sections 14a, 14b of the stator winding 6.

Furthermore, in accordance with FIG. 1, the stator 2 having the stator body 7 and the stator teeth 8 is arranged axially between a first and a second end shield 25a, 25b. As revealed by FIG. 1, a part of the coolant distributor chamber 4 is arranged in the first end shield 25a and a part of the coolant collector chamber 5 is arranged in a second end shield 25. The coolant distributor chamber 4 is thus delimited both by the first end shield 25a and by the plastic composition 11. Correspondingly, the coolant collector chamber 5 is delimited both by the second end shield 25b and by the plastic composition 11.

The coolant distributor chamber 4 and the coolant collector chamber 5 are in each case partly formed by a cavity 41a, 41b provided in the plastic composition 11. The first cavity 41a is supplemented by a cavity 42a embodied in the first end shield 25a to form the coolant distributor chamber 4. Correspondingly, the second cavity 41b is supplemented by a cavity 42b embodied in the second end shield 25b to form the coolant collector chamber 5.

Furthermore, a coolant feed 35 can be embodied in the first end shield 25a and fluidically connects the coolant distributor chamber 4 to a coolant inlet 33 provided on the outside, in particular on the circumferential side as illustrated in FIG. 1, of the first end shield 25a. Correspondingly, a coolant discharge 36 can be embodied in the second end shield 25b and fluidically connects the coolant collector chamber 5 to a coolant inlet 34 provided on the outside, in particular on the circumferential side as illustrated in FIG. 1, of the end shield 25b. This enables an arrangement of the coolant distributor chamber 4 and/or of the coolant collector chamber 5 in each case radially on the outside of the first and/or second end section 14a, 14b of the relevant stator winding 6 and also in the extension of said end sections 14a, 14b along the axial direction A. The end sections 14a, 14b of the stator windings 6, said end sections being particularly subjected to thermal loading during operation of the machine 1, can be cooled particularly effectively in this way.

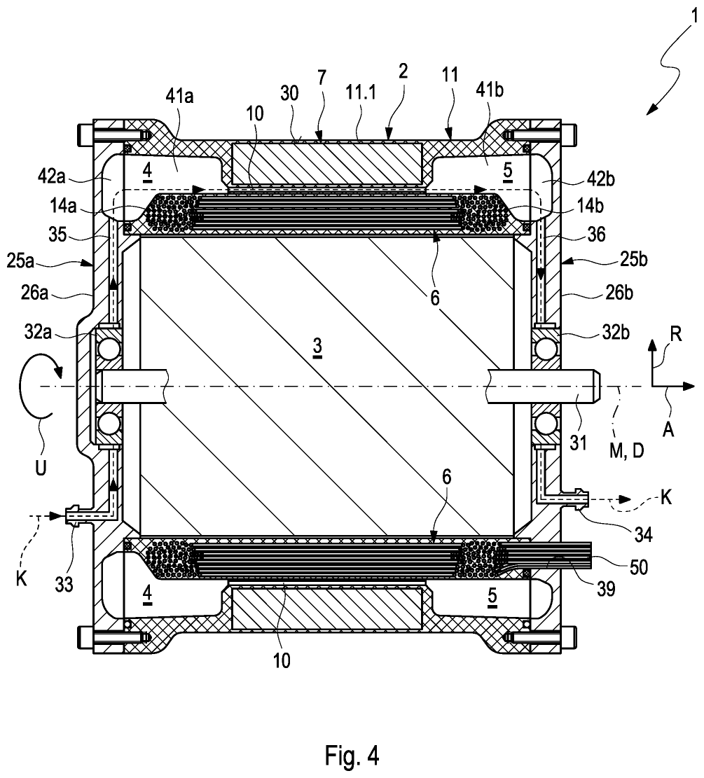

In accordance with FIG. 3, the interspace 9 comprises a first subspace 9c, in which the stator winding 6 is arranged, and a second subspace 9d, in which the cooling channel 10 is arranged and which supplements the first subspace 9c to form the interspace 9. As revealed by FIGS. 3 and 4, a positioning device 27 can be arranged between the two subspaces, by means of which positioning device the cooling channel 10 is positioned in the second subspace 9d. Said positioning device 27 comprises two projections 28a, 28b embodied on the two stator teeth 8a, 8b which are adjacent in the circumferential direction U and delimit the interspace 9. The two projections 28a, 28b face one another in the circumferential direction U and project into the interspace for the purpose of positioning the cooling channel. For the cooling channel 10 embodied as a tube body 16 or a flat tube 17, the projections 28a, 28b act as a radial stop that prevents an undesired movement of the cooling channel 10, in particular during the production of the plastic composition 11 or by means of injection molding, radially inward.

In accordance with FIG. 1, the plastic composition 11 composed of the electrically insulating plastic can also be arranged on an outer circumferential side 30 of the stator body 7 and can form a plastic coating 11.1 on the outer circumferential side 30. The stator body 7 of the stator 2, said stator body typically being formed from electrically conductive stator plates, can thus be electrically insulating from the surroundings. The provision of a separate housing for accommodating the stator body 7 can thus be obviated.

In order to produce an electrical machine 1 in accordance with FIGS. 1 to 3, firstly the electrical insulation 15, for example composed of paper, is inserted into the interspaces 9. Afterward, the stator windings 6 are introduced into the interspaces 9 and encapsulated by injection molding with the plastic that produces the plastic composition 11, for example a thermosetting plastic. Afterward, the perforations 40 forming the cooling channel 2 are introduced into the plastic composition 11 with the aid of a suitable drilling tool. In the course of the production of the plastic composition 11, the stator body 7 can also be encapsulated by injection molding with the plastic that produces the plastic composition 11, that is to say in particular with the thermosetting plastic. The coolant distributor chamber 4 and the coolant collector chamber 5 are likewise produced in the course of the injection-molding process.

FIG. 4 shows a variant of the example from FIG. 1 in the longitudinal section along the rotation axis D of the rotor 3. In order also to cool the rotor shaft 31 and the two shaft bearings 32a, 32b during operation of the machine 1, the coolant feed 35 can be thermally coupled to the first shaft bearing 32a arranged in the first end shield 25a. Likewise, the coolant discharge 36 can be thermally coupled to the second shaft bearing 32b arranged in the second end shield 25b. A separate cooling device for cooling the shaft bearings 32a, 32b can be obviated in this way, which results in cost advantages. In the example in FIG. 4, the coolant inlet 33 and the coolant outlet 34 are provided on the outer end side 26a and 26b, respectively, of the first and second end shields 25a, 25b, respectively. In the case of the variant in accordance with FIGS. 4 and 1, the stator windings 6 are arranged radially within the cooling channels 10 with respect to the radial direction R. The stator windings 6 are led out of the stator 2 toward the outside with an electrical connection 50 through a bushing 39 provided in the second end shield 25b, such that said stator windings can be electrically energized from outside. The bushing 39 is arranged between the coolant distributor chamber 4 and/or the coolant collector chamber 5 and the rotation axis D with respect to the radial direction R.

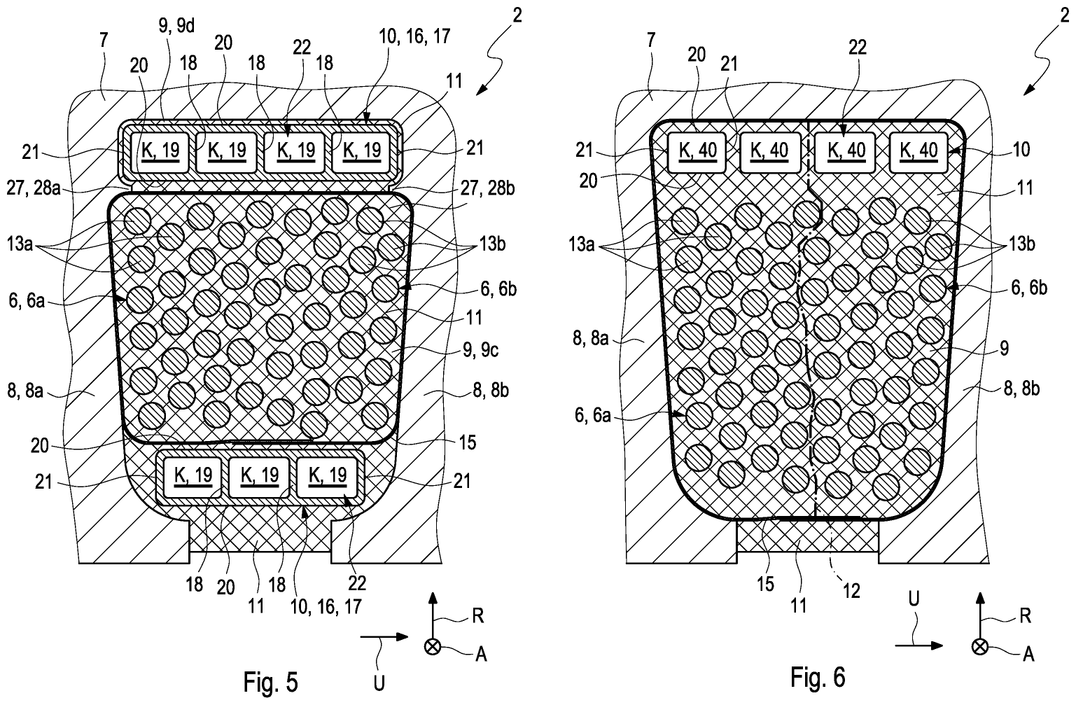

FIG. 5 shows a development of the example from FIG. 3. The development in FIG. 5 differs from the example from FIG. 3 in that a cooling channel 10 is provided in the interspace 9 not only radially on the outside but additionally also radially on the inside, which cooling channel can be embodied as a tube body 16 or as a flat tube 17 as in the example from FIG. 3. By way of example, the radially inner cooling channel 10 is illustrated as a flat tube 17 having two separating elements 18 and three partial cooling channels 19. Explanations above concerning the example from FIG. 3 are also applicable, insofar as they are meaningful, mutatis mutandis, to the example in FIG. 5.

Attention shall now be directed to the illustration in FIG. 6, which shows a detailed illustration of an interspace 9 embodied between two stator teeth 8 which are adjacent in the circumferential direction U, said stator teeth hereinafter also being referred to as stator teeth 8a, 8b. In order to improve the heat transfer of the waste heat generated by the stator windings 6 to the coolant K flowing through the cooling channels 10, in accordance with FIG. 6, a plastic composition 11 composed of a plastic is in each case provided in the interspaces 9. The cooling channel 10 arranged in the interspace 9 and the stator winding(s) 6 arranged in the same interspace 9 are embedded into the plastic composition 11, which can for example consist of a thermosetting plastic or comprise a thermosetting plastic. In the example in FIG. 6, a plastic composition 11 composed of a single plastic material is provided in the interspace 9.

It goes without saying that the stator winding 6 arranged in the interspace 9 in accordance with FIG. 6 in each case is partly associated with a first stator winding 6a, carried by a first stator tooth 8a, and is partly assigned to a second stator winding 6b, carried by a second stator tooth 8b, which is adjacent to the first stator tooth 8a in the circumferential direction U. In order to elucidate this scenario, a possible virtual separating line 12 is depicted in FIG. 6—in a manner analogous to FIG. 3. The winding wires 13a shown to the left of the separating line 12 in FIG. 6 belong to the stator winding 6a carried on the stator tooth 8a. The winding wires 13b shown to the right of the separating line 12 thus belong to the stator winding 6b carried by the second stator tooth 8b.

In the example in FIG. 6, the cooling channel 10 embodied in a respective interspace 9 is realized by a plurality of perforations 40 provided in the plastic composition 11, through which perforations the coolant K can flow. The perforations 40—four such perforations 40 are shown purely by way of example in FIG. 6—are arranged at a distance from one another along the circumferential direction U and extend in each case along the axial direction A. The perforations 40 can be realized as through holes introduced into the plastic composition 11 by means of a suitable drilling tool. The perforations 40 in the cross section perpendicular to the rotation axis D can have in each case the geometry of a rectangle having two broad sides 20 and having two narrow sides 21. Here a length of the two broad sides 20 is at least two times, preferably at least four times, a length of the two narrow sides 21. The advantageous geometry of a flat tube is thus emulated.

As further revealed by the detailed illustration in FIG. 3, an electrical insulation 15 composed of an electrically insulating material is arranged in the respective interspace 9 between the plastic composition 11 and the stator body 7 or the two stator teeth 8 delimiting the interspace 9 in the circumferential direction U. In this way, in the case where the plastic composition 11 cracks on account of thermal overloading or is damaged in some other way, it is possible to avoid an undesired electrical short circuit of the affected stator winding 6 with the material of the stator body 7 or of the stator teeth 8—typically iron or some other electrically conductive material. An electrical insulation 15 composed of paper proves to be particularly cost-effective.

In the example in FIG. 6, the perforations 40 forming the cooling channel 10 are arranged radially outside the stator windings 6 in the plastic composition 11 with respect to the radial direction R. The radial distance between the cooling channel 10 and the rotation axis D of the rotor 3 is thus greater than the distance between the stator winding 6 and the rotation axis D. In the cross section perpendicular to the axial direction A as shown in FIG. 6, the two broad sides 20 of the perforations 40 extend in each case perpendicular to the radial direction R.

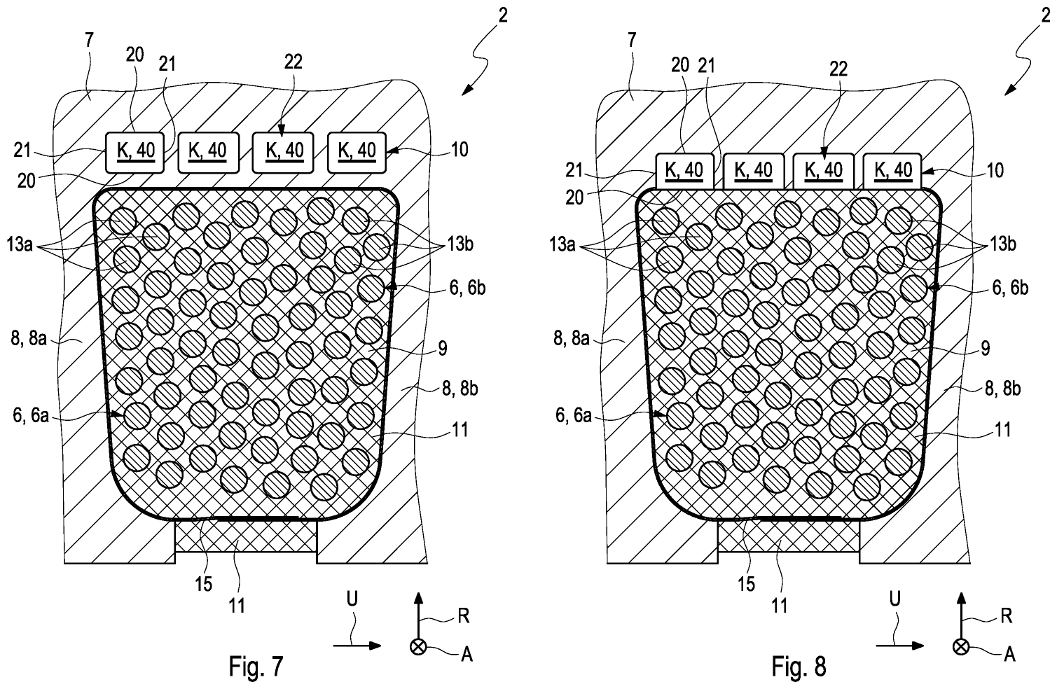

FIG. 7 shows a variant of the example from FIG. 6. In the case of the machine 1 in accordance with FIG. 7, the cooling channel 10 is not arranged in the plastic composition 11, but rather in the stator body 7 of the stator 2. As revealed by FIG. 7, the perforations 40 forming the cooling channel 10 are arranged radially outside the interspace 9 and with respect to the circumferential direction U between two adjacent stator teeth 8a, 8b in the stator body 7. In a manner analogous to the example from FIG. 6, the cooling channel 10 is formed by perforations 40 provided in the stator body 7. The cooling channel 10 can thus be formed in the course of the production of the stator body 7 by introducing the perforations 40—preferably in the form of holes drilled with the aid of a suitable drilling tool—into the stator body 7 or into the stator body plates forming the stator body 7.

FIG. 8 shows a variant of the example from FIG. 7. In the case of the variant in accordance with FIG. 8, too, the perforations 40 forming the cooling channel 10 are arranged in the stator body 7 of the stator 2. In the example in FIG. 8, the perforations 40 arranged in the stator body 7 are embodied as open toward the interspace 9. As revealed by FIG. 8, the perforations 40 are closed off in a fluid-tight manner toward the interspace 9 and by the plastic composition 11 provided in the interspace 9.

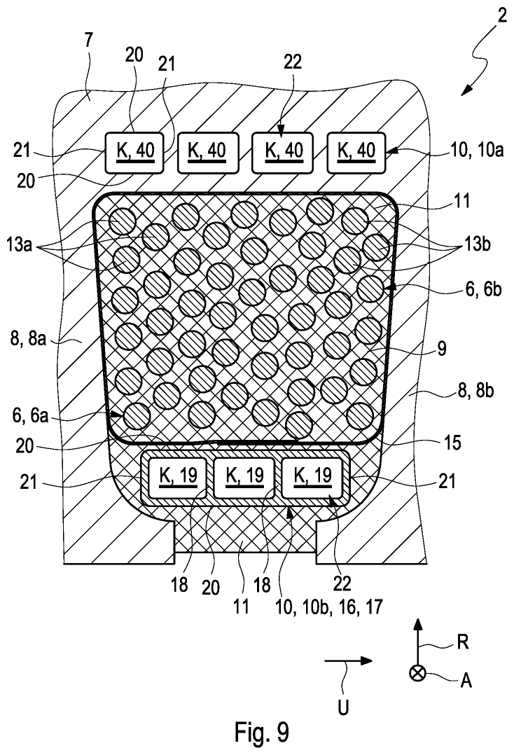

FIG. 9 shows a development of the example from FIG. 8. In the case of the machine 1 in accordance with FIG. 9, a cooling channel 10 is provided both in the stator body 7 and in the plastic composition 11. The cooling channel 10 provided in the stator body 7—hereinafter also referred to as “radially outer cooling channel” 10a—is embodied in a manner analogous to the example from FIG. 8, and so reference is made to explanations above concerning FIG. 8. The cooling channel 10 arranged in the plastic composition 11 is hereinafter also referred to as “radially inner cooling channel” 10b. With respect to the radial direction R, the stator winding 6 is thus arranged between the two cooling channels 10a, 10b. As shown by the detailed illustration in FIG. 9, the radially outer cooling channel 10b can be formed by a tube body 16, for example composed of aluminum, which surrounds a tube body interior 22. Optionally, as shown in the detailed illustration in FIG. 9, one or more separating elements 18 can be shaped on the tube body 16, and subdivide the cooling channel 10 into partial cooling channels 19 fluidically separated from one another. The flow behavior of the coolant K in the cooling channel 10 can be improved in this way, which is associated with an improved heat transfer to the coolant. Moreover, the tube body 16 is additionally mechanically reinforced. In the example in FIG. 9, two such separating elements 18 are illustrated by way of example, thus resulting in three partial cooling channels 19. Of course, a different number of separating elements 18 is also possible in variants of the example. The tube body 16 can be embodied as a flat tube 17 having two broad sides 20 and two narrow sides 21 in cross section perpendicular to the axial direction A. In this case, a length of the two broad sides 20 is at least four times, preferably at least ten times, a length of the two narrow sides 21. The broad sides 20 extend perpendicular to the radial direction R.

The variants in accordance with FIGS. 3 to 9 as discussed above can be combined with one another, insofar as this is practical.

The plastic composition 11 can also surround that winding section of the stator winding 6 which projects axially from the interspace 9 of the stator body, and in so doing partly delimit the coolant distributor chamber 4 and/or the coolant collector chamber 5, such that the relevant stator winding 6 or the relevant winding section of the stator winding 6 is electrically insulated from the coolant when the latter is passed through the relevant cooling channel 10 during operation of the machine 1.

Expediently, the coolant distributor chamber 4 and the coolant collector chamber 5 are arranged in an axial extension of the stator body 7 adjacent to the latter. Preferably, the coolant distributor chamber 4 and/or the coolant collector chamber 5 do(es) not project beyond the stator body 7 or stator 2 along the radial direction R thereof.

The stator winding 6 is embodied in each case such that it is electrically insulated from the coolant K and from the stator body 7 of the stator 2 at least in the region within the respective interspace 9 during operation of the electrical machine 1. An undesired electrical short circuit of the stator winding 6 with the stator body 7—during operation of the electrical machine 1—with the coolant K is prevented in this way. Expediently, such an electrical insulation of the stator winding 6 vis-à-vis the stator body 7—preferably also vis-à-vis the stator teeth 8 delimiting the interspace 9—is formed completely by the plastic composition 11 and/or by the additional electrical insulation 15—already mentioned above.

Expediently, the additional electrical insulation 15 extends within the interspace 9 over the entire length of the interspace 9 as measured along the axial direction A, such that it insulates the stator winding 6 from the stator body 7 and/or from the stator teeth 8. The additional electrical insulation 15 likewise expediently encloses the stator winding 6 within the interspace 9 over at least the entire length of the interspace 9 along the circumferential boundary thereof. Expediently, the stator winding 6 is also electrically insulated from the cooling channel embodied as a tube body 16. In this case, the electrical insulation is formed by the plastic composition and, alternatively or additionally, the additional electrical insulation 15.

1. An electrical machine, comprising:
a rotor, which is rotatable about a rotation axis defining an axial direction of the electrical machine, and a stator having stator windings; and
a coolant distributor chamber and a coolant collector chamber arranged axially at a distance therefrom, wherein the coolant distributor chamber communicates fluidically with the coolant collector chamber via at least one cooling channel through which a coolant is flowable to cool the stator windings, wherein at least one stator winding is embedded into a plastic composition composed of an electrically insulating plastic for thermal coupling;
wherein at least one of the coolant distributor chamber and the coolant collector chamber is arranged in a region of at least one of a first axial end section and a second axial end section of at least one stator winding; and
wherein at least one of the coolant distributor chamber and the coolant collector chamber is arranged at least partly in the plastic composition for thermal coupling to the at least one stator winding.

2. The electrical machine as claimed in claim 1, wherein at least one of the coolant distributor chamber and the coolant collector chamber is arranged radially on an outside of at least one of the first end section and the second end section of the at least one stator winding.

3. The electrical machine as claimed in claim 1, wherein at least one of the coolant distributor chamber and the coolant collector chamber has a ring-shaped geometric shaping in a cross section perpendicular to the rotation axis of the rotor.

4. The electrical machine as claimed in claim 1, wherein the plastic composition at least partly delimits at least one of the coolant distributor chamber and the coolant collector chamber.

5. The electrical machine as claimed in claim 1, wherein at least one of the coolant distributor chamber and the coolant collector chamber is formed by a cavity embodied at least partly, in the plastic composition.

6. The electrical machine as claimed in claim 1, wherein the at least one cooling channel is embedded into the plastic composition.

7. The electrical machine as claimed in claim 1, wherein:
the stator has stator teeth extending along the axial direction and arranged at a distance from one another along a circumferential direction of the rotor, said stator teeth carrying the stator windings; and
the plastic composition, the at least one cooling channel, and the at least one stator winding are arranged in an interspace embodied between two stator teeth that are adjacent in the circumferential direction.

8. The electrical machine as claimed in claim 7, wherein:
the interspace comprises a first subspace in which the at least one stator winding is arranged, and a second subspace in which the at least one cooling channel is arranged; and
a positioning aid is arranged between the two subspaces and via which the at least one cooling channel is positionable in the second subspace.

9. The electrical machine as claimed in claim 8, wherein:
the positioning aid comprises two projections embodied at two stator teeth adjacent in the circumferential direction; and
the two projections face one another in the circumferential direction and project into the interspace to position the at least one cooling channel.

10. The electrical machine as claimed in claim 1, wherein:
in at least one interspace between two adjacent stator teeth, the plastic composition consists of a single plastic material; and
an electrical insulation composed of an electrically insulating material is arranged in the interspace.

11. The electrical machine as claimed in claim 10, wherein the electrical insulation is arranged between the stator winding and an associated stator tooth.

12. The electrical machine as claimed in claim 1, wherein at least one of:
the electrically insulating plastic includes a thermosetting plastic or is a thermosetting plastic; and
the electrically insulating plastic comprises a thermoplastic or is a thermoplastic.

13. The electrical machine as claimed in claim 7, the at least one cooling channel is provided in at least one interspace between two stator teeth adjacent in the circumferential direction.

14. The electrical machine as claimed in claim 1, the at least one cooling channel is arranged at least one of radially outside and radially within a respective stator winding in an interspace between two adjacent stator teeth.

15. The electrical machine as claimed in claim 1, wherein:
the at least one cooling channel is embodied as a tube body surrounding a tube body interior; and
at least one separating element is shaped at the tube body and subdivides the tube body interior into at least two partial cooling channels which are fluidically separated from one another.

16. The electrical machine as claimed in claim 15, wherein the tube body is embodied as a flat tube having two broad sides and two narrow sides.

17. The electrical machine as claimed in claim 16,
wherein in a cross section perpendicular to the axial direction at least one of the two broad sides extends substantially perpendicular to a radial direction.

18. The electrical machine as claimed in claim 1, wherein the at least one cooling channel is arranged completely in the plastic composition.

19. The electrical machine as claimed in claim 1, wherein the at least one cooling channel is formed by at least one perforation provided in the plastic composition and through which the coolant is flowable.

20. The electrical machine as claimed in claim 19, wherein the at least one perforation in a cross section perpendicular to the axial direction has a geometry of a rectangle having two broad sides and two narrow sides.

21. The electrical machine as claimed in claim 1, wherein the at least one cooling channel is arranged in a stator body of the stator and is formed by at least one perforation through which the coolant is flowable.

22. The electrical machine as claimed in claim 21, wherein the at least one perforation is open toward an interspace embodied between two adjacent stator teeth and is closed in a fluid-tight fashion by the plastic composition arranged in the interspace.

23. The electrical machine as claimed in claim 1, wherein at least one cooling channel is provided in the plastic composition, and at least one cooling channel is provided in a stator body of the stator.

24. The electrical machine as claimed in claim 1, wherein:
the stator is arranged along the axial direction between a first end shield and a second end shield, which lie axially opposite one another;
at least one of: (i) a part of the coolant distributor chamber is arranged in the first end shield, and (ii) a part of the coolant collector chamber is arranged in the second end shield; and
the two end shields are embodied as separate components which at least partly delimit at least one of the coolant distributor chamber and the coolant collector chamber, respectively.

25. The electrical machine as claimed in claim 24, wherein at least one of:
a coolant feed is embodied in the first end shield and fluidically connects the coolant distributor chamber to a coolant inlet provided on an outside of the first end shield;
the coolant feed is thermally connected to a first shaft bearing for a rotatable mounting of the stator, said first shaft bearing being provided in the first end shield;
a coolant discharge is embodied in the second end shield and fluidically connects the coolant collector chamber to a coolant outlet provided on an outside of the second end shield; and
the coolant discharge is thermally connected to a second shaft bearing for the rotatable mounting of the stator, said second shaft bearing being provided in the second end shield.

26. The electrical machine as claimed in claim 1, wherein the plastic composition is an injection-molded composition composed of the electrically insulating plastic.

27. The electrical machine as claimed in claim 1, wherein the plastic composition is embodied in integral fashion.

28. The electrical machine as claimed in claim 1, wherein:
the stator comprises a stator body; and
the plastic composition is arranged on an outer circumferential side of the stator body and forms an outer coating on said outer circumferential side.

29. The electrical machine as claimed in claim 1, wherein the plastic composition at least partly surrounds at least one winding section of the at least one stator winding that projects axially from an interspace embodied between two adjacent stator teeth, and partly delimits at least one of the coolant distributor chamber and the coolant collector chamber such that said at least one winding section is electrically insulated from the coolant during operation of the electrical machine.

30. The electrical machine as claimed in claim 1, wherein the coolant distributor chamber communicates fluidically with the coolant collector chamber via a plurality of cooling channels.

31. The electrical machine as claimed in claim 30, wherein the plurality of cooling channels extend at a distance from one another along the axial direction.

32. The electrical machine as claimed in claim 30, wherein the plurality of cooling channels are arranged at a distance from one another along a circumferential direction of the stator.

33. The electrical machine as claimed in claim 1, wherein at least one of the coolant distributor chamber and the coolant collector chamber is arranged exclusively in an axial extension of a stator body or of the stator adjacent thereto and projects at most to the axial extension along a radial direction of the stator body or the stator.

34. The electrical machine as claimed in claim 1, wherein the at least one stator winding is electrically insulated from the coolant and from a stator body of the stator at least in a region within a respective interspace embodied between two adjacent stator teeth during operation of the electrical machine.

35. The electrical machine as claimed in claim 34, wherein an electrical insulation of the at least one stator winding from at least one of the stator body and the stator teeth delimiting the interspace is formed completely by at least one of the plastic composition and an electrical insulation composed of an electrically insulating material is arranged in the interspace.

36. The electrical machine as claimed in claim 10, wherein the electrical insulation extends within the interspace over an entire length of the interspace as measured along the axial direction, such that the electrical insulation insulates the at least one stator winding from a stator body of the stator and from the stator teeth delimiting the respective interspace.

37. The electrical machine as claimed in claim 10, wherein the electrical insulation encloses the at least one stator winding within the interspace over at least the entire length of the interspace along a circumference thereof.

38. The electrical machine as claimed in claim 36, wherein the at least one stator winding is electrically insulated from the at least one cooling channel, which is embodied as a tube body surrounding a tube body interior, by at least one of the plastic composition and the electrical insulation.

39. The electrical machine as claimed in claim 1, wherein the stator windings are part of a distributed winding.

40. A vehicle comprising at least one electrical machine including:
a rotor, which is rotatable about a rotation axis defining an axial direction of the electrical machine, and a stator having stator windings; and
a coolant distributor chamber and a coolant collector chamber arranged axially at a distance therefrom, wherein the coolant distributor chamber communicates fluidically with the coolant collector chamber via at least one cooling channel through which a coolant is flowable to cool the stator windings, wherein at least one stator winding is embedded into a plastic composition composed of an electrically insulating plastic for thermal coupling;
wherein at least one of the coolant distributor chamber and the coolant collector chamber is arranged in a region of at least one of a first axial end section and a second axial end section of at least one stator winding; and
wherein at least one of the coolant distributor chamber and the coolant collector chamber is arranged at least partly in the plastic composition for thermal coupling to the at least one stator winding.
